(19) United States
(12) Patent Application Publication
(10) Pub. No.: US 2025/0315624 A1
(43) Pub. Date: Oct. 9, 2025

(54) SENTIMENT ANALYSIS FOR CUSTOMERS OF A COMMUNICATION NETWORK

(71) Applicant: DISH Wireless L.L.C., Englewood, CO (US)

(72) Inventors: Karupaiah Rajendran, Sachse, TX (US); Ahmed Awwad Whdan, Centennial, CO (US)

(21) Appl. No.: 18/626,969

(22) Filed: Apr. 4, 2024

(51) Int. Cl. G06F 40/30; G06Q 30/0282

(52) U.S. Cl. CPC G06F 40/30; G06Q 30/0282

(57) ABSTRACT

A method for sentiment analysis regarding a communication network of a communication service provider (CSP) includes collecting a set of customer comments from one or more online platforms. Each customer comment includes text and is related to the communication network of the CSP. The method further includes generating a profile for each customer comment in the set of customer comments, providing the text of each customer comment to a natural language processing (NLP) neural network, using the NLP neural network to generate at least a sentiment classification and an issue classification for each customer comment based on the text of the customer comment, generating one or more reports based on one or more of the sentiment classification and the issue classification of each customer comment, and transmitting at least one report to a department of the CSP based on one or more of the sentiment classification or the issue classification.

### BACKGROUND

Wireless communication networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers and other devices. 5G technologies are capable of supplying much greater bandwidths than was previously available.

### SUMMARY

In accordance with an embodiment, a method for sentiment analysis regarding a communication network of a communication service provider (CSP) includes collecting, using a sentiment analysis system, a set of customer comments from one or more online platforms. Each customer comment includes text and is related to the communication network of the CSP. The method further includes generating, using a pre-processing module, a profile for each customer comment in the set of customer comments, providing the text of each customer comment to a natural language processing (NLP) neural network, generating, using the NLP neural network, at least a sentiment classification and an issue classification for each customer comment based on the text of the customer comment, generating, using a post-processing module, one or more reports based on one or more of the sentiment classification and the issue classification of each customer comment, and transmitting, using the sentiment analysis system, at least one report to a department of the CSP based on one or more of the sentiment classification or the issue classification.

In accordance with another embodiment, a system for sentiment analysis regarding a communication network of a communication service provider (CSP) includes an input for receiving a set of customer comments collected from one or more online platforms. Each customer comment includes text and is related to the communication network of the CSP. The system further includes a pre-processing module coupled to the input and configured to generate a profile for each customer comment in the set of customer comments, a natural language processing (NLP) neural network coupled to the pre-processing module and configured to generate at least a sentiment classification and an issue classification for each customer comment based on the text of the customer comment, and a post-processing module coupled to the NLP neural network and configured to generate one or more reports based on one or more of the sentiment classification and the issue classification of each customer comment.

In accordance with another embodiment, a non-transitory, computer readable medium storing instructions that, when executed by one or more electronic processors, perform a set of functions. The set of functions includes collecting a set of customer comments from one or more online platforms. Each customer comment includes text and is related to a communication network of a communication service provider (CSP). The set of functions further includes generating a profile for each customer comment in the set of customer comments, providing the text of each customer comment to a natural language processing (NLP) neural network, generating, using the NLP neural network, at least a sentiment classification and an issue classification for each customer comment based on the text of the customer comment, generating one or more reports based on one or more of the sentiment classification and the issue classification of each customer comment, and transmitting at least one report to a department of the CSP based on one or more of the sentiment classification or the issue classification.

### BRIEF DESCRIPTION OF THE DRAWINGS

The present disclosure will hereafter be described with reference to the accompanying drawings, wherein like reference numerals denote like elements.

FIG. 1 is a schematic block diagram of a system for sentiment analysis regarding a communication network in accordance with an embodiment;

FIGS. 2A and 2B illustrate example customer comments in accordance with an embodiment;

FIG. 3 illustrates an example profile for a customer comment before classification in accordance with an embodiment;

FIG. 4 illustrates an example profile for a customer comment after classification in accordance with an embodiment;

FIG. 5 illustrates an example report for sentiment analysis in accordance with an embodiment;

FIG. 6 illustrates a method for sentiment analysis regarding a communication network in accordance with an embodiment; and

FIG. 7 is a schematic block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

Communication service providers (CSPs) can receive comments from customers (e.g., subscribers) on the communication network services and the associated consumer products (hardware and software) used to enable access to the network services of the CSP on multiple platforms which can be operated by third parties. For example, a customer can purchase a subscription and/or a consumer product (e.g., a SIM card, a mobile phone) associated with a subscription at an online marketplace platform and provide a comment at the online marketplace regarding customer experience with communication network services and/or associated consumer product. As used herein, the term comments can be used generally to refer to various forms of feedback including, for example, reviews, ratings, likes, etc. regarding customer experience. In another example, the CSP may have a web site (e.g., hosted by a web service platform) that allows a customer (or subscriber) to provide comments on the CSP's network services and associated consumer products. In yet another example, the CSP may have a page or a profile on a social media platform of a third party that allows a customer to provide comments on the CSP's network services and associated consumer products. It can be difficult to gauge customer experience due to the high volume of comments across multiple platforms.

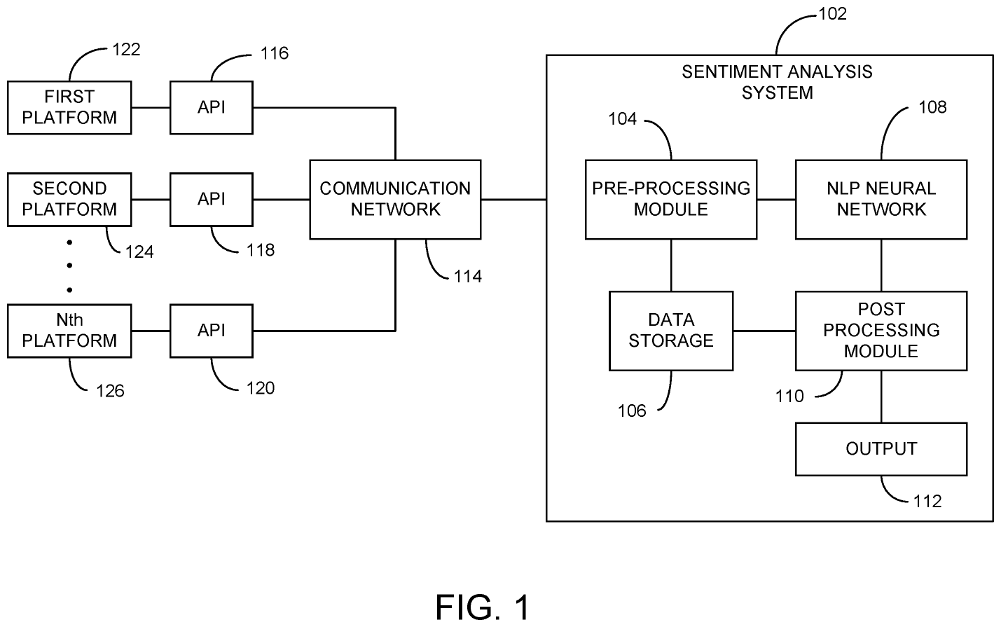

The present disclosure describes systems and methods for an automated sentiment analysis of customer experience regarding a wireless communication network. Sentiment analysis is an artificial intelligence based approach to interpreting the emotion conveyed by textual data. The described systems and methods can advantageously enable, for example, collecting comments from customers and other data associated with the comments from a plurality of platforms, aggregating the comments and associated data, analyzing the comments and associated data, generating actionable insights, and enhancing the customer experience based on the actionable insights. FIG. 1 is a schematic block diagram of a system for sentiment analysis regarding a communication network in accordance with an embodiment. The sentiment analysis system 102 can include a pre-processing module 104, data storage 106, a natural language processing (NLP) neural network 108, a post-processing module 110 and an output 112. In some embodiments, the sentiment analysis system 102 can be associated with a communication service provider (CSP) or carrier that provides communication network services.

The sentiment analysis system 102 may be configured to connect to and communicate with a communication network 114 in order to communicate with a plurality of platforms 122, 124, 126 to collect customer comments and associated data related to communication network services and/or consumer products associated with the communication network services provided by the CSP associated with the sentiment analysis system 102. In some embodiments, the communication network 114 may utilize a radio access technology such as, for example, a 4G Long Term Evolution (LTE) network, a fifth generation (5G) new radio (NR) standalone network, or further technology releases such as 6G, etc. In some embodiments, the sentiment analysis system 102 can collect data from a plurality (N) of platforms 122, 124, 126 where each platform can be operated by a third party. In addition, each platform 122, 124, 126 can be configured to receive customer comments regarding the communication network services and/or consumer products associated with the communication network services, as well as data associated with the customer comments. In one example, a platform 122, 124, 126, may be an online marketplace platform that sells subscriptions to the communication network service (e.g., cellular network service) of a CSP and/or consumer products (e.g., a SIM card, a mobile phone, etc.) that enable access to the communication network service. In another example, a platform 122, 124, 126 may be a web site hosted by a web service platform and associated with the CSP. In yet another example, a platform 122, 124, 126 may be a social media platform that includes a page or profile associated with the CSP. In some embodiments, an optional interface, for example, an application programming interface (API) 116, 118, 120 may be provided by each platform 122, 124, 126, respectively, to allow the sentiment analysis system 102 to access and collect the customer comments and associated data from the respective platform 122, 124, 126.

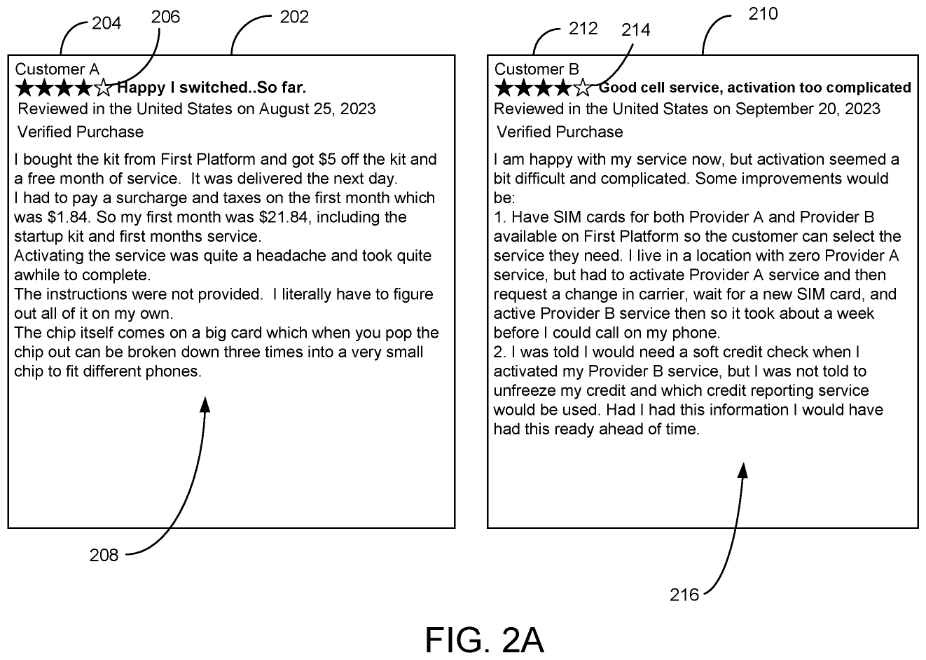

As mentioned above, the customer comments collected from one or more platforms 122, 124, 126 can include various forms of feedback including, for example, reviews, ratings, likes, etc. regarding customer experience related to communication network services and/or consumer products associated with the communication network services of the CSP. FIGS. 2A and 2B illustrate example customer comments in accordance with an embodiment. In FIG. 2A, a first comment 202 and a second comment 210 provide examples of positive feedback on a communication network service of a CSP. The first comments 202 can include a customer identifier 204 (e.g., a username the customer uses for an account on the particular platform), a rating 206, and the body 208 of the comment. The second comment 210 can include a customer identifier 212, a rating 214, and the body 216 of the comment. In FIG. 2B, a first comment 220 and a second comment 230 provide examples of negative feedback on a communication network service of a CSP. The first comments 220 can include a customer identifier 222, a rating 224, and the body 226 of the comment. The second comment 230 can include a customer identifier 232, a rating 234, and the body 236 of the comment. As illustrated, each comment 202, 210, 220, and 230 can both text-based data such as, for example, the body 208, 216, 226, 236 of the comment and non-text based data, for example, in FIGS. 2A and 2B the ratings 206, 214, 224, 234 can be illustrated graphically using stars. In some embodiments, ratings may also be provided as text.

Returning to FIG. 1, as mentioned above, each customer comment may also have other associated data that can be collected by the sentiment analysis system 102 from a platform 122, 124, 126. In some embodiments, the additional data associated with each customer comment can include one or more of, for example, location information (e.g., country, state, city, zip code), IP address, a device used to post the comment (e.g., a desktop computer, a mobile device such as, e.g., a mobile phone, a laptop computer, etc.), a user ID (e.g., name, phone number), a communication network used by the customer to post the comment, a date the comments was posted, a time the comment was posted, etc. In some embodiments, the sentiment analysis system 102 may be configured to collect customer comments and associated data from one or more platforms 122, 124, 136 at a predetermined time, repeatedly at a predetermined interval, for a predetermine time frame, etc.

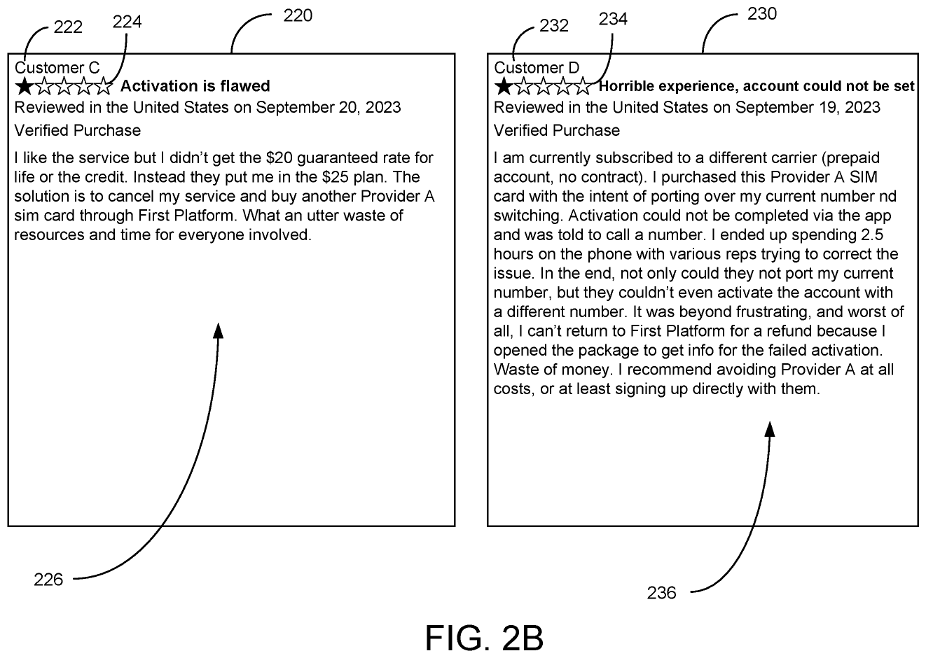

The customer comments and associated data collected by the sentiment analysis system 102 from the platforms 122, 124, 126 may be stored in data storage (or memory) 106. The collected customer comments and associated data may also be provided as input to the pre-processing module 104. The pre-processing module 104 can be configured to create a profile for each customer comment that includes the text of the comment and the associated data, for example, in the form of a table entry. In some embodiments, the pre-processing module 104 may also be configured to, for example, remove noise, remove irrelevant content, and remove duplicative entries (e.g., duplicative data for a particular customer comment or duplicative customer comments). In some embodiments, the pre-processing module 104 can be configured to determine a location of the customer who posted the comment from, for example, an IP address associated with the customer comment. In some embodiments, the pre-processing module 104 may be configured to determine additional information about the customer who posted a comment based on information available from the CSP associated with the sentiment analysis system 102 (e.g., the IP address of the customer may match an IP address provided by the CSP or the customer ID (e.g. a phone number) may match an existing customer of the CSP). In addition, the pre-processing module 104 can be configured to tokenize and structure the textual data of each customer comment for further analysis, for example, using the NLP neural network 108 to classify each comment (as described further below). FIG. 3 illustrates an example profile for a customer comment before classification in accordance with an embodiment. In FIG. 3, the profile data in the example profile for a customer comment can include data (or information) 302 collected from the platforms 122, 124, 126. For example, in FIG. 3, the example profile includes the platform 306, the comment 308 (i.e., the text of the comment), and location information 310 (i.e., as provided by the platform). The profile data in the example profile in FIG. 3 also includes classification information 304 for the customer comment that can be determined using the NLP neural network 108, for example, a sentiment classification 312, an issue classification 314, a predicted location 316, etc. The customer comment profile shown in FIG. 3 is an example and in some embodiments, the profile can include additional collected data and classification information.

Returning to FIG. 1, after pre-processing, the text (or textual data) of each customer comment may be provided to the NLP neural network 108. In some embodiments, the NLP neural network 108 can be configured to perform one or more NLP tasks. For example, as mentioned above, the NLP neural network 108 can be configured to classify each customer comment including, for example, a sentiment classification and issue classification. The sentiment classification can classify the sentiments expressed in a comment as, for example, positive, negative, or neutral. The issue classification can classify issues (e.g., the type of problem or an aspect of the service that was successful) raised in the comment. In some embodiments, the NLP neural network 108 can also be configured to detect information such as, for example, a location, a device used to post a comment, etc. in the text of the comment. In some embodiments, the issue classification can include categories such as, for example, network, billing, payment, and on-boarding, as well as subcategories. For example, in some embodiments, the category of network can include subcategories such as coverage, connection speed, slow speed, dropped call, international call/roaming, quality of connection, etc. The category of billing can include subcategories such as, for example, invoice, incorrect invoice, missing invoice, resolution, etc. The category of payment can include, for example, late payment, incorrect payment method, payment process, etc. The category of on-boarding can include, for example, activation, account set up, etc. In some embodiments, the NLP neural network 108 can be configured to generate other classifications based on the analysis of the text. The classifications generated by the NLP neural network 108 can be selected by an operator of the sentiment analysis system 102. In some embodiments, the NLP neural network 108 can be fine-tuned with additional training to address false negatives and false positives, to add additional types of classification, to add additional subcategories of classification, and to improve accuracy and relevance. For example, training data can be created that includes training samples that each include a customer comment with a ground truth for the one or more classifications of the customer comment. The training samples can then be input to the NLP neural network 108 during a training process. In some embodiments, the NLP neural network 108 can be a neural network pre-trained for NLP tasks generally and then additional training may be performed for the specific application of the NLP neural network 108, for example, for the classification of customer comments regarding communication network services and consumer products provided by a CSP.

The NLP neural network 108 can be implemented as, for example, an artificial neural network (ANN) such as, for example, a multilayer perceptron (MLP) neural network, a convolution neural network (CNN), a recurrent neural network (RNN), etc. The NLP neural network 108 can be trained using known methods such as, for example, supervised learning, backpropagation, self-supervised learning, semi-supervised learning, etc. As one example, to perform supervised learning, the training data can include example inputs and corresponding desired (for example, actual) outputs, and NLP neural network 108 progressively develops a model that maps inputs to the outputs included in the training data. As another example, to perform self-supervised learning, the NLP neural network 108 can be trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data).

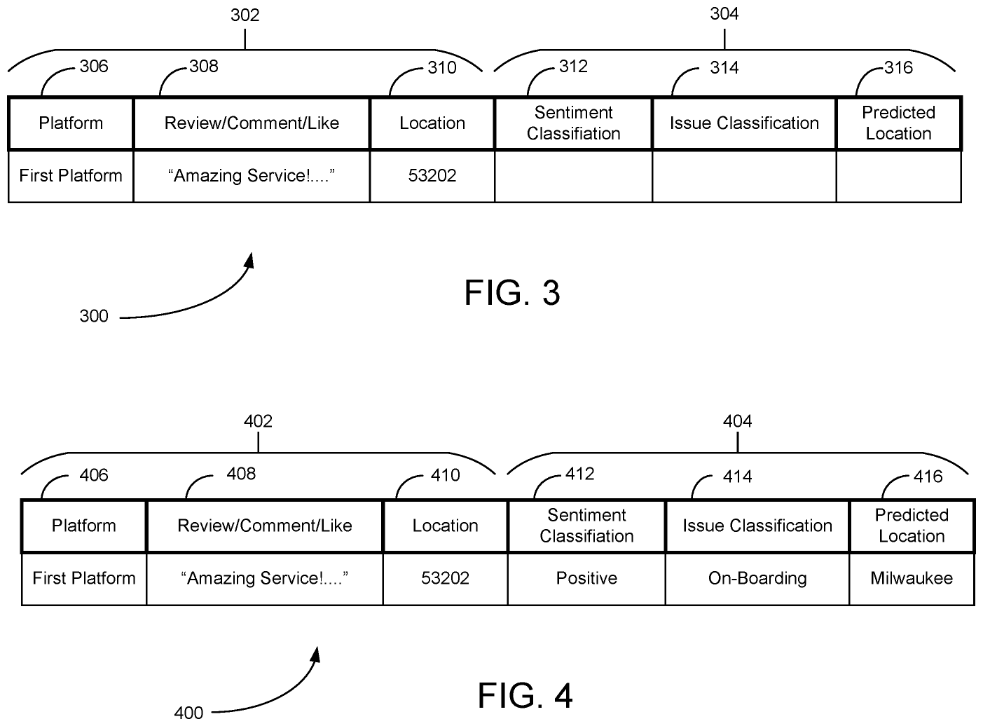

The output generated by the NLP neural network 108 for each customer comment (e.g., sentiment classification, issue classification (category and sub-categories), predicted location, etc.) can be provided to a post-processing module 110. The post-processing module 110 may be configured to fill out the profile created for a customer comment with the output generated by the NLP neural network 108. FIG. 4 illustrates an example profile for a customer comment after classification in accordance with an embodiment. As mentioned above, the profile data in the example profile for a customer comment can include data (information) 402 collected from the platforms 122, 124, 126 (shown in FIG. 1) such as, for example, the platform 406, the comment 408 (i.e., the text of the comment), and location information 410 (i.e., as provided by the platform). The profile data in the example profile in FIG. 4 also includes classification information 404 for the customer comment determined using the NLP neural network 108, as discussed above). In the example of FIG. 4, the NLP neural network 108 determined the sentiment classification 412 is positive, the issue classification 414 is an on-bearding issue, and the predicted location 416 is Milwaukee. In some embodiments, as mentioned above, the predicted location 416 can be determined based on the text of the customer comment. For the example shown in FIG. 4, the customer comment may include language that indicates a possible location such as, for example, “I purchased the SIM card in Milwaukee.” The updated profile for each customer comment with the output generated by the NLP neural network 108 for the customer comment may be stored in data storage 106. The customer comment profile shown in FIG. 4 is an example and in some embodiments, the profile can include additional collected data and classification information.

Returning to FIG. 1, in some embodiments, the post-processing module 110 can be configured to determine a sentiment score for each customer comment which can also be stored in data storage 106. In some embodiments, the sentiment score can be determined by converting the text of a customer comment into a number, for example in a predetermined range or scale, to gauge the service quality. For example, the predetermined range or scale may be from 0 to 5, where 0 can be the worst and 5 can be the best, and each number (or level) in the range can be mapped to predetermined words or sentiments. In one example, a customer comment can include the words or phrases “bad,” “poor service,” “will not use this service again,” and “poor voice quality,” and each of these words/phrases can have a score of zero. In this example, the average of the scores would provide an overall score of zero for the customer comment, which can reflect a low overall sentiment score and thus a low service quality (or service score). In another example, a customer comment can include the phrase “good cell service” which can be mapped to a score of 5 and the phrase “activation is flawed” which can be mapped to a score of 1. In this example, the average of the scores would provide an overall score of 3 for the customer comment, which can reflect a moderate overall sentiment score. In some embodiments, the post-processing module may be configured to resolve a conflict between the collected data for a comment and a classification or prediction made by the NLP neural network 108. In an example, the data collected from a platform for a customer comment may identify a first city as the location of the customer who posted the comment and the NLP neural network 108 may predict a second, different city as the location based on words or phrases in the text of the comment. In some embodiments, the post-processing model may select the location information (e.g., the first city) provided in the data collected from the platform that is associated with the customer comment. In some embodiments, the customer comment can be input back into the NLP neural network 108 to fine-tune the model of the NLP neural network 108 regarding the location prediction.

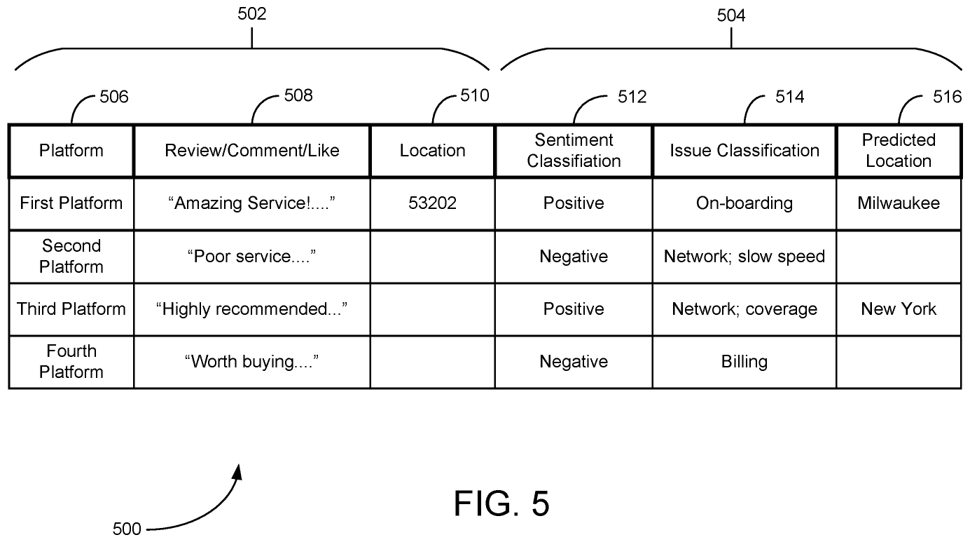

In some embodiments, the post-processing module 110 can be configured to generate a report that can include the collected data and classifications one or more customer comments. FIG. 5 illustrates an example report for sentiment analysis in accordance with an embodiment. In FIG. 5, an example report 500 includes collected information 502 such as, for example, platform 506, comment 508, and location 510 and classification information 504 such as, for example, sentiment classification 512, issue classification 514, and predicted location 516. The report 500 shown in FIG. 5 is an example and in some embodiments, the report can include additional collected data and classification information. The report 500 can include an entry (e.g., a row) for each of a plurality of customer comments from multiple platforms. For example, the report 500 includes an entry for a customer comment from a first platform, an entry for a customer comment from a second platform, an entry for a customer comment from a third platform, and an entry for a customer comment from a fourth platform. As mentioned above, the different platforms can be, for example, an online marketplace, a web site, a social media platform, etc.

In some embodiments, the post-processing module 110 can be configured to categorize the customer comments based on the collected data and/or the classification information generated by the NLP neural network 108. One or more reports may then be generated which include customer comments and the associated profile data (e.g., collected data and classification information) for a specific category or combination of categories. In one example, a report may include customer comments that have been classified as positive. In another example, a report may include customer comments that have be classified for a particular issue category or subcategory, for example, a network category or a subcategory such as, for example, coverage, connection speed. In another example, a report can include customer comments associated with a particular location. In yet another example, a report may include comments that have been classified as negative, for a specific issue classification category and subcategory and for a specific location (e.g., a city). For example, a report may be created that includes customer comments classified as negative, network issue, slow speed, Dallas, Texas. In yet another example, a report can include customer comments with a predetermine sentiment score.

In some embodiments, report(s) generated by the post-processing module 110 can be stored in data storage 106. In addition, the report(s) may be provided as an output 112 of the sentiment analysis system 102. In some embodiments, one or more reports may be output 112 at regular intervals, for example, daily, weekly, or monthly. In some embodiments, the sentiment analysis system can be advantageously configured to distribute a report (i.e., output 112) including one or more customer comments and the associated data for each comment to one or more departments (e.g., customer support, network support, product development, marketing, billing, etc.) of the CSP associated with the sentiment analysis system 102. A report can be directed to a department based on, for example, the categorization of the customer comments included in the report. In one example, if a report includes customer comments that have been classified as negative comments related to a network issue or problem, the report may be distributed to a network support department and a customer support department. A report may be distributed by, for example, electronic transmission over an internal communication network or over an external communication network.

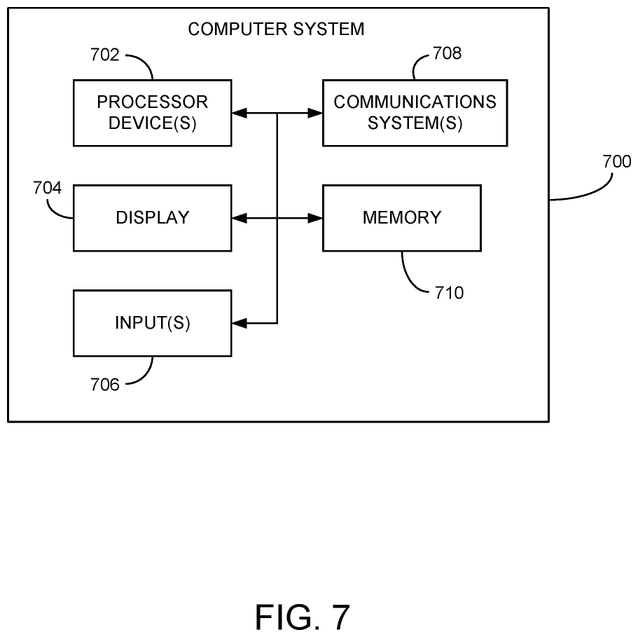

In some embodiments, various components of the sentiment analysis system 102 (e.g., the pre-processing module 104, the NLP neural network 108, the post-processing module 110) can be implemented on a computer system (e.g., computer system 700 discussed below with respect to FIG. 7). While FIG. 1 illustrates various components of the system for sentiment analysis, other embodiments of the system for sentiment analysis can vary the arrangement, communication paths, and specific components of the system. In some embodiments, the system can include fewer, additional, or different components in different configurations than illustrated in FIG. 1.

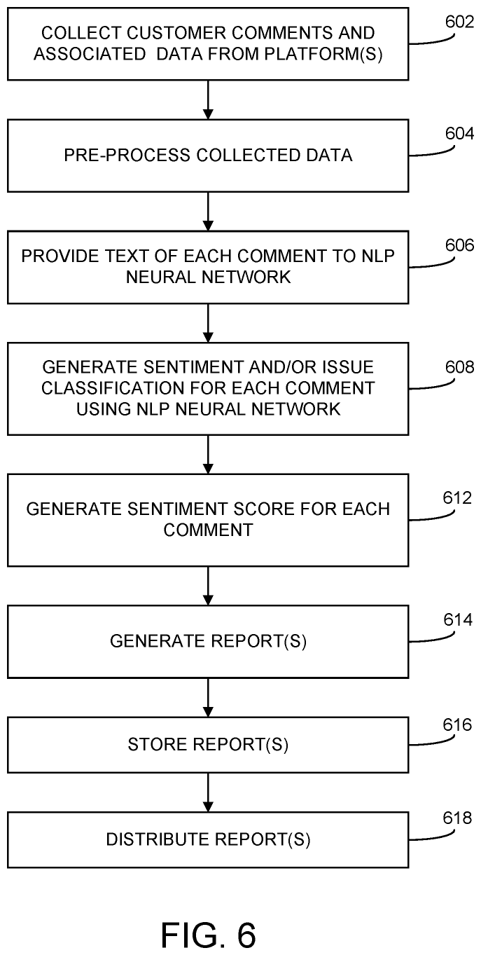

FIG. 6 illustrates a method for sentiment analysis regarding a communication network in accordance with an embodiment. The process illustrates in FIG. 6 is described as being carried out by the system illustrated in FIG. 1. However, in some examples, the process of FIG. 6 may be implemented by another system. Although the blocks of the process are illustrated in a particular order, in some embodiments, one or more blocks may be executed in a different order than illustrated in FIG. 6.

At block 602, customer comments and associated data for each comment can be collected or retrieved from one or more platforms. As mentioned above, a sentiment analysis system 102 associated with a CSP may be configured to connect to and communicate with a communication network 114 in order to communicate with one or more platforms 122, 124, 146 to collect customer comments and associated data. The customer comments can be related to communication network services and/or consumer products associated with the communication network services provided by the CSP associated with the sentiment analysis system 102. In some embodiments, the customer comments can be collected from a plurality of platforms (e.g., online marketplaces, web sites, social media platforms) and each platform can be operated by a third party. As mentioned above, the customer comments collected from the one or more platforms 122, 124, 126 can include various forms of feedback including, for example, reviews, ratings, likes, etc. regarding customer experience related to communication network services and/or consumer products associated with the communication network services of the CSP. The data associated with each customer comment can include one or more of, for example, location information (e.g., country, state, city, zip code), IP address, a device used to post the comment (e.g., a desktop computer, a mobile device such as, e.g., a mobile phone, a laptop computer, etc.), a user ID (e.g., name, phone number), a communication network used by the customer to post the comment, a date the comments was posted, a time the comment was posted, etc. As mentioned above, customer comments and associated data may be collected from one or more platforms 122, 124, 136 at a predetermined time, repeatedly at a predetermined interval, for a predetermine time frame, etc.

At block 604, the collected data (e.g., customer comments and associate data) can be pre-processed by the sentiment analysis system 102 using, for example, a pre-processing module 104. As mentioned, pre-processing of the comments an include, for example, generating a profile for each customer comment that includes the text of the comment and the associated data, removing noise, removing irrelevant content, removing duplicative entries (e.g., duplicative data for a particular customer comment or duplicative customer comments), determining a location of the customer who posted the comment, determining additional information about the customer who posted a comment based on information available from the CSP associated with the sentiment analysis system, and tokenizing and structuring the textual data of each customer comment for further analysis.

At block 606, the text (or textual data) of each customer comment may be provided to an NLP neural network 108 which can be configured to perform one or more NLP tasks. For example, as mentioned above, the NLP neural network 108 can be configured to classify each customer comment including, for example, a sentiment classification (e.g., a classification of the sentiments expressed in a comment as, for example, positive, negative, or neutral) and issue classification (e.g., a classification of issues (e.g., the type of problem or an aspect of the service that was successful) raised in the comment including both categories and sub-categories if issues). In some embodiments, the NLP neural network 108 can also be configured to detect information such as, for example, a location, a device used to post the comments, etc. in the text of the comment. At block 608, the NLP neural network 108 can generate a sentiment classification, issue classification, or other classification (e.g., detecting a location) for each customer comment based on the text of the comment. In one example, if a comment includes the term “excellent download speed” and the phrase “I would buy this again,” the comment may be classified as a positive comment and related to the network and marketing. At block 610, a sentiment score may be determined or generated for each customer comment using, for example, a post-processing module 110.

At block 612, one or more reports may be generated that can include the collected data and classifications of one or more customer comments. For example, a report may be generated that includes all of the customer comments. In another example, a report may be generated for a subset of the customer comments based on, for example, the classifications of the comments generated by the NLP neural network 108 and/or the associated data of the comments. For example, a report may be generated that includes negative customer comments for a given geographic area for a given type of issue. In another example, a report may be generated that includes positive customer comments for a given type of issue and sub-category of the issue. As mentioned above, one or more reports may be generated at regular intervals, for example, daily, weekly, or monthly. At block 614, the report(s) generated at block 612 (e.g., using the post-processing module 110) can be stored in data storage 106.

At block 616, the one or more generated report(s) may each be distributed to one or more departments (e.g., customer support, network support, product development, marketing, billing, etc.) of the CSP associated with the sentiment analysis system 102. As mentioned above, a report (e.g., including one or more customer comments and associate data for each comment) can be directed to a department based on, for example, the categorization of the customer comments included in the report. In an example, one hundred customer comments are classified as negative in a particular geographic region (e.g., a city) for a network coverage issue (e.g., the customer comments indicate that there is an issue with poor coverage in the geographic area). In the example, the one hundred comments can be aggregated and included in a report that may be distributed to an RF team in network support department and/or a marketing department. Accordingly, the departments to which a report is distributed many then analyze the issue and take action to improve coverage in the geographic area where the customer are submitting the negative comments (e.g., a complaint).

Advantageously, in some embodiments, the collected customer comments (and associated data) and generated classifications for the customer comments can be used to summarize, for example, main issues, trends and sentiment fluctuations in customer feedback. For example, in some embodiments, daily updates and reports on customer satisfaction may be generated to highlight key insights and issues. In some embodiments, the generated reports can facilitate cross-functional collaboration by sharing the actionable insights with different departments (or teams), as well as can encourage data-driven decision-making to improve customer experience.

As mentioned above, various components of the system for sentiment analysis of customer experience regarding a wireless communication network may be implemented on a computer system. FIG. 7 is a schematic block diagram of an example computer system in accordance with an embodiment. The computer system 700 (e.g., a server) may include one or more processor devices 702, a display 704, one or more inputs 706, one or more communication systems 708, and memory 710. In some embodiments, processor device(s) 702 can be any suitable hardware processor or combination of processors, such as a central processing unit (CPU), a graphics processing unit (GPU), a microprocessor, an application specific integrated circuit (ASIC), field programmable gate arrays (FPGA), digital signal processors (DSPs), etc. The processor device(s) 702 may include one or more processors, processor cores, processing elements, processor clusters, or other electronic processing units. Accordingly, a processing function described as being performed by the processor device(s) 702 may include multiple processors, processor cores, processing elements, processing clusters, etc. (of the processor device(s) 702) performing aspects or portions (sub-functions) of the processing function to complete the processing function. The one or more electronic processing units of the processor device(s) 702 may include one or more microprocessors, application-specific integrated circuits (“ASICs”), or other suitable electronic device for processing data. At least in some examples, the one or more electronic processing units of the processor device(s) 702 can be co-located physically (e.g., in the same facility, building, room, rack, or computing housing) as part of the computer system 700.

In some embodiments, display 704 can include any suitable display devices, such as a computer monitor, a touchscreen, a television, etc. In some embodiments, display 704 can be omitted. In some embodiments, inputs 706 can include any suitable input devices and/or sensors that can be used to receive user input, such as a keyboard, a mouse, a touchscreen, a microphone, a graphical user interface (GUI), a voice user interface (VOI), mechanical switches, buttons, knobs, etc. and allow a user or operator to interact with the system for sentiment analysis. In some embodiments, inputs 706 can be omitted.

In some embodiments, communications system(s) 708 can include any suitable hardware, firmware, and/or software for communicating information over any suitable communication network (e.g., communication network 114 shown in FIG. 1). For example, communication system(s) 708 can include one or more transceivers, one or more communication chips and/or chip sets, etc. In a more particular example, communication system(s) 708 can include hardware, firmware and/or software that can be used to establish a Wi-Fi connection, a Bluetooth connection, a cellular connection an Ethernet connection, etc.

In some embodiments, memory 710 can include any suitable storage device or devices (e.g., one or more non-transitory computer readable media) that can be used to store instructions, values, etc., that can be used, for example, by processor device 702 to present content using display 704, to communicate with a communication network, to communicate with other computer systems, etc. Memory 710 can include any suitable volatile memory, non-volatile memory, storage, or any suitable combination thereof. For example, memory 710 can include RAM, ROM, EEPROM, one or more flash drives, one or more hard disks, one or more solid state drives, one or more optical drives, etc. The memory 710 may store data and/or instructions for use and execution by the computer system 700 (e.g., by the processor device(s) 702) to implement the functionality of, for example, the pre-processing module 104, the NLP neural network 108, the post-processing module 110, etc. described herein. For example, the memory 710 may include or store the pre-processing module 104, the NLP neural network 108, and the post-processing module 110, shown in FIG. 1, respectively. In some embodiments, the functionality described herein as being performed by the computer system 700 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodies on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on. As specific examples, a control device can include a processor, a microcontroller, a field-programmable gate array, a programmable logic controller, logic gates, etc., and other types of components that are known in the art for implementation of appropriate functionality (e.g., memory, communication systems, power sources, user interfaces, and other inputs, etc.).

Certain operations of the methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A method for sentiment analysis regarding a communication network of a communication service provider (CSP), the method comprising:
collecting, using a sentiment analysis system, a set of customer comments from one or more online platforms, wherein each customer comment comprises text and is related to the communication network of the CSP;
generating, using a pre-processing module, a profile for each customer comment in the set of customer comments;
providing the text of each customer comment to a natural language processing (NLP) neural network;
generating, using the NLP neural network, at least a sentiment classification and an issue classification for each customer comment based on the text of the customer comment;
generating, using a post-processing module, one or more reports based on one or more of the sentiment classification and the issue classification of each customer comment; and
transmitting, using the sentiment analysis system, at least one report to a department of the CSP based on one or more of the sentiment classification or the issue classification.

2. The method according to claim 1, wherein collecting the set of customer comments further comprises collecting a set of associated data for each customer comment, and wherein the profile generated for each customer comment includes the associated data for the customer comment.

3. The method according to claim 1, wherein the one or more online platforms is one or more of an online marketplace, a web site, or a social media platform.

4. The method according to claim 1, further comprising generating, using the NLP neural network, a predicted location for at least one customer comment of the set of customer comments based on the text of the at least one customer comment.

5. The method according to claim 1, wherein the sentiment classification is one of positive, negative, or neutral.

6. The method according to claim 1, wherein the issue classification includes one or more categories of issues related to performance of the communication network of the CSP.

7. A system for sentiment analysis regarding a communication network of a communication service provider (CSP), the system comprising:
an input for receiving a set of customer comments collected from one or more online platforms, wherein each customer comment comprises text and is related to the communication network of the CSP;
a pre-processing module coupled to the input and configured to generate a profile for each customer comment in the set of customer comments;
a natural language processing (NLP) neural network coupled to the pre-processing module and configured to generate at least a sentiment classification and an issue classification for each customer comment based on the text of the customer comment; and
a post-processing module coupled to the NLP neural network and configured to generate one or more reports based on one or more of the sentiment classification and the issue classification of each customer comment.

8. The system according to claim 7, wherein the system for sentiment analysis system is further configured to transmit at least one report to a department of the CSP based on one or more of the sentiment classification or the issue classification.

9. The system according to claim 8, wherein the department of the CSP is one or more of network support, customer support, product development, marketing, or billing.

10. The system according to claim 7, wherein the set of customer comments includes associated data collected from the one or more online platforms for each customer comment, and wherein the profile generated for each customer comment includes the associated data for the customer comment.

11. The system according to claim 7, wherein the one or more online platforms is one or more of an online marketplace, a web site, or a social media platform.

12. The system according to claim 7, wherein the NLP neural network is further configured to generate a predicted location for at least one customer comment of the set of customer comments based on the text of the at least one customer comment.

13. The system according to claim 7, wherein the NLP neural network is an artificial neural network.

14. A non-transitory, computer readable medium storing instructions that, when executed by one or more electronic processors, perform a set of functions, the set of functions comprising:
collecting a set of customer comments from one or more online platforms, wherein each customer comment comprises text and is related to a communication network of a communication service provider (CSP);
generating a profile for each customer comment in the set of customer comments;
providing the text of each customer comment to a natural language processing (NLP) neural network;
generating, using the NLP neural network, at least a sentiment classification and an issue classification for each customer comment based on the text of the customer comment;
generating one or more reports based on one or more of the sentiment classification and the issue classification of each customer comment; and
transmitting at least one report to a department of the CSP based on one or more of the sentiment classification or the issue classification.

15. The non-transitory computer-readable medium according to claim 14, wherein collecting the set of customer comments further comprises collecting a set of associated data for each customer comment, and wherein the profile generated for each customer comment includes the associated data for the customer comment.

16. The non-transitory computer-readable medium according to claim 15, wherein the associated data includes one or more of a location, an IP address, a device used to post the customer comment, a user ID, a date of posting the customer comment, or a time of posting the customer comment.

17. The non-transitory computer-readable medium according to claim 14, wherein the one or more online platforms is one or more of an online marketplace, a web site, or a social media platform.

18. The non-transitory computer-readable medium according to claim 14, the set of functions further comprising generating, using the NLP neural network, a predicted location for at least one customer comment of the set of customer comments based on the text of the at least one customer comment.

19. The non-transitory computer-readable medium according to claim 14, wherein the sentiment classification is one of positive, negative, or neutral.

20. The non-transitory computer-readable medium according to claim 14, wherein the issue classification includes one or more categories of issues related to performance of the communication network of the CSP.
